(19) United States
(12) Patent Application Publication
(10) Pub. No.: US 2025/0229456 A1
(43) Pub. Date: Jul. 17, 2025

(54) Intelligent Drum Cycles for Concrete Mixers

(71) Applicant: Total Vehicle Solutions Group Limited, Wisbech (GB)

(72) Inventors: John Davies, Buckingham (GB); Kevin Walker, Wisbech (GB); Matthew Hicks, Buckingham (GB); Vito Ronzano, Jr., Wisbech (GB)

(21) Appl. No.: 19/105,815

(22) PCT Filed: Jul. 21, 2023
(86) PCT No.: PCT/GB2023/051926

§ 371 Date: Feb. 23, 2025

(30) Foreign Application Priority Data
Jul. 21, 2022 (GB) 2210705.6

(51) Int. Cl. B28C 5/42; B60P 3/16; G05B 13/02

(52) U.S. Cl. CPC B28C 5/422; B28C 5/4237; B28C 5/4244; B60P 3/16; G05B 13/0265

(57) ABSTRACT

This specification relates to systems (100), methods and apparatus for intelligently controlling the drum rotation of a concrete mixer (104). According to a first aspect of this specification, there is described a method for controlling a concrete mixing drum (104) on a concrete mixer vehicle (102), the method comprising, for each of a plurality of time-steps: inputting, into one or more machine-learned models (210), input data comprising a current state of the concrete mixer vehicle and one or more delivery requirements for a concrete mix in the concrete mixing drum; processing, using the one or more machine-learned models, the input data to generate a drum rotation cycle data (c) for the concrete mixing drum; outputting, from the one or more machine-learned models, the drum rotation cycle data; and controlling the concrete mixing drum based on the generated drum rotation cycle data.

### FIELD

This specification relates to systems, methods and apparatus for intelligently controlling the drum rotation of a concrete mixer.

### BACKGROUND

Concrete mixers have traditionally had manual drum speed controls, allowing the operator to use levers to set drum speed whilst the vehicle motor is at a fixed rpm. This method of control is low fidelity, links the drum speed to the vehicle/motor speed, such that drum speed varies during a journey, and also does not allow continuous drum control. Consequently, the delivered concrete mix may not meet the requirements of the task at hand, e.g. the slump of the concrete mix may not be correct.

Furthermore, operators often set a high forward drum speed, i.e. moving the load forward continuously, to avoid spillage. This may impact the vehicle safety, as high rotation speed of payloads can increase the chances of drum separation or overturning. It may also be energy inefficient.

### SUMMARY

According to a first aspect of this specification, there is described a method for controlling a concrete mixing drum on a concrete mixer vehicle, the method comprising, for each of a plurality of time-steps: inputting, into one or more machine-learned models, input data comprising a current state of the concrete mixer vehicle and one or more delivery requirements for a concrete mix in the concrete mixing drum; processing, using the one or more machine-learned models, the input data to generate a drum rotation cycle data for the concrete mixing drum; outputting, from the one or more machine-learned models, the drum rotation cycle data; and controlling the concrete mixing drum based on the generated drum rotation cycle data.

The current state of the concrete mixer vehicle may be at least in part derived from sensor data collected from sensors coupled to the concrete mixer drum.

The current state of the concrete mixer vehicle comprises one or more of: a longitudinal and/or latitudinal acceleration of the concrete mixer vehicle; a longitudinal and/or latitudinal inclination of the concrete mixer vehicle; a speed of the concrete mixer vehicle; a remaining journey time of the concrete mixer vehicle; a current slump of the concrete mix in the concrete mixing drum; a current location of the concrete mixer vehicle; a concrete mixing drum power; a concrete mixing drum speed; and or a temperature.

The one or more delivery requirements may comprise a plurality of scores, each corresponding to weighting of a predefined requirement associated with delivery of the concrete mix in the concrete mixing drum. The predefined requirements may comprise one or more of: energy use; safety; spillage; mixing; and/or slump. The delivery requirements may alternatively or additionally comprise a target slump value of the concrete mix upon delivery.

Processing the input data to generate the drum rotation cycle data for the concrete mixing drum may comprise: processing the current state of the concrete mixer vehicle using a gating model to determine a classification of the current state of the concrete mixer vehicle; selecting a control model from a plurality of control models based on the classification of the current state of the concrete mixer vehicle; and processing, using the selected control model, the input data to generate the drum rotation cycle data. The gating model and/or plurality of control models may comprise the one or more machine-learned models.

The one or more machine-learned model may comprises: a neural network; a recurrent neural network; a regression model; a reinforcement learning model; a support vector machine; and/or a random forest.

According to a further aspect of this specification, there is described a method for determining a drum rotation profile for a concrete mixing drum on a concrete mixer vehicle, the method comprising: receiving input data comprising a journey route for the concrete mixer vehicle and one or more delivery requirements for a concrete mix in the concrete mixing drum; generating, by one or more machine-learned models and based on the input data, a drum rotation profile for the concrete mixing drum, the drum rotation profile comprising a set of control commands for controlling the concrete mixing drum, the control commands each associated with respective part of the journey route; and controlling the concrete mixing drum based at least in part on the drum rotation profile during travel of the concrete mixer vehicle along the journey route.

Generating the drum rotation profile for the concrete mixing drum may comprise, for each of a plurality of locations on the journey route: estimating a state of the concrete mixer vehicle at a respective location on the journey route; inputting, into the one or more machine-learned models, data comprising the estimated current state of the concrete mixer vehicle and the one or more delivery requirements for a concrete mix; processing, using the one or more machine-learned models, the data to generate respective drum rotation cycle data for the concrete mixing drum at the respective location; and adding the respective drum rotation cycle data for the concrete mixing drum and the respective location to the drum rotation profile.

The estimated state of the concrete mixer vehicle at a respective location on the journey route may comprise one or more of: a longitudinal and/or latitudinal acceleration of the concrete mixer vehicle; a longitudinal and/or latitudinal inclination of the concrete mixer vehicle; a speed of the concrete mixer vehicle; a remaining journey time of the concrete mixer vehicle; a current slump of the concrete mix in the concrete mixing drum; a current location of the concrete mixer vehicle; a concrete mixing drum power; a concrete mixing drum speed; and or a temperature.

The one or more delivery requirements may comprise a plurality of scores, each corresponding to weighting of a predefined factor associated with delivery of the concrete mix in the concrete mixing drum.

The method may further comprise: determining, based on the drum rotation profile for the concrete mixing drum, one or more delivery properties of the journey route; and outputting the one or more delivery properties of the journey route, wherein the one or more properties comprise one or more of: an energy prediction for the journey; a safety prediction for the journey; a spillage prediction for the journey; a mixing prediction for the journey; and/or a slump prediction for the journey.

According to a further aspect of this specification, there is disclosed a computer implemented method for controlling a mixing drum of a concrete mixing vehicle, the method comprising: determining a current state of the concrete mixing vehicle from sensor data received from a plurality sensors monitoring properties of the vehicle; selecting, based on the current state of the concrete mixing vehicle, an operating mode from a plurality of operating modes for the concrete mixing drum; and controlling, based on the selected state, rotation of the concrete mixing drum.

The plurality of operating modes may comprise a delivering mode in which the rotation of the concrete mixing drum is controlled using the method of any of claims 1 to 8, and wherein the delivery mode is selected based on one or more of: a payload being present in the concrete mixing drum; a post-charging cycle being completed; one or more scheduled deliveries remaining; a speed of the concrete mixing vehicle; and/or location of the concrete mixing vehicle.

The plurality of operating modes may comprise a charging mode in which the concrete mixing drum rotates in a charging direction at a predefined charging speed to push a payload forwards in the drum.

The plurality of operating modes may comprise a discharging mode in which the concrete mixing drum rotates in a discharging direction at a predefined charging speed to push a payload backwards in the drum.

The plurality of operating modes may comprise a pre-discharging mode, in which: a slump of a concrete payload in the mixer is determined; an amount of water required to reach a target slump value is determined based on the determined slump of the concrete payload and a target slump value; the determined amount of water is added to the concrete payload; and the concrete drum rotates at a predefined rate to mix the concrete payload.

According to a further aspect of this specification, there is disclosed a computer program product comprising computer readable instructions that, when executed by a computing system, cause the system to perform any one or more of the methods described herein.

According to a further aspect of this specification, there is disclosed a concrete mixer vehicle comprising: a concrete mixing drum; control apparatus configured to cause the concrete mixer vehicle to perform any one or more of the methods disclosed herein.

### BRIEF DESCRIPTION OF THE DRAWINGS

Example implementations will be described by way of reference to the accompanying drawings, in which:

FIG. 1 shows a schematic diagram of a concrete mixing system on a vehicle;

FIG. 2 shows a schematic overview of an example method for controlling a concrete mixing drum on a concrete mixer vehicle;

FIG. 3 shows a schematic overview of a further example method for controlling a concrete mixing drum on a concrete mixer vehicle

FIG. 4 shows a schematic overview of a method for determining a drum rotation profile for a concrete mixing drum on a concrete mixer vehicle;

FIG. 5 shows a flow diagram of an example method for controlling a concrete mixing drum on a concrete mixer vehicle;

FIG. 6 shows a flow diagram of an example method for determining a drum rotation profile for a concrete mixing drum on a concrete mixer vehicle;

FIG. 7 shows a flow diagram of an example method for controlling a mixing drum of a concrete mixing vehicle; and

FIG. 8 shows a schematic example of a computing system/apparatus for performing any of the methods described herein.

### DETAILED DESCRIPTION

The systems, apparatus and methods described herein are based on drum intelligence that takes account of its own performance, what it has as a payload, and/or what is important in the charging/delivery/discharging, to come up with the optimum drum cycles and predicted information to enhance energy use, safety, delivery slump and/or other delivery properties of the concrete mix.

Multiple factors may be taken into account when delivering each concrete payload, such as:
Payload mass/volume
Payload slump
Payload aeration

These payload factors play against the backdrop of other key delivery factors, such as:
Drum geometry—size, design, screw type etc.
Route—fast/slow average speed, long/short duration, straight/twisty roads, stop/start or A-roads etc.

Furthermore, are different and competing delivery requirements when delivering concrete, such as:
Energy efficiency—not rotating the drum, or rotating slower or intermittently uses less energy
Safety/Overturning—rotating the drum causes load to move laterally/vertically and can increase likelihood of overturning or drum separation, especially when cornering.
Spill Avoidance—rotating the drum so that the load is pushed forwards in the drum helps reduce spillage, especially when accelerating
Mixing/Aeration—rotating the drum mixes the load and can help avoid separation of concrete ingredients, and can also help preserve concrete aeration
Slump/De—aeration-rotating a mix increases water evaporation rate and hence slump reduction, which can in turn also lead to de-aeration (i.e. mixing can introduce/preserve aeration, but over-long mixing can reduce aeration)

In order to optimise the drum cycle during the delivery of the concrete, one or more of these factors and one or more requirements are entered into a multi-factor ML model that is trained on known data (e.g. energy use with different slump/rotation speeds) and also mechanistic modelling of drum load with rotation, accelerations or the like. The model attempts optimise the drum cycle over the journey so that the best compromise between all requirements is arrived at, taking into account the relevant factors.

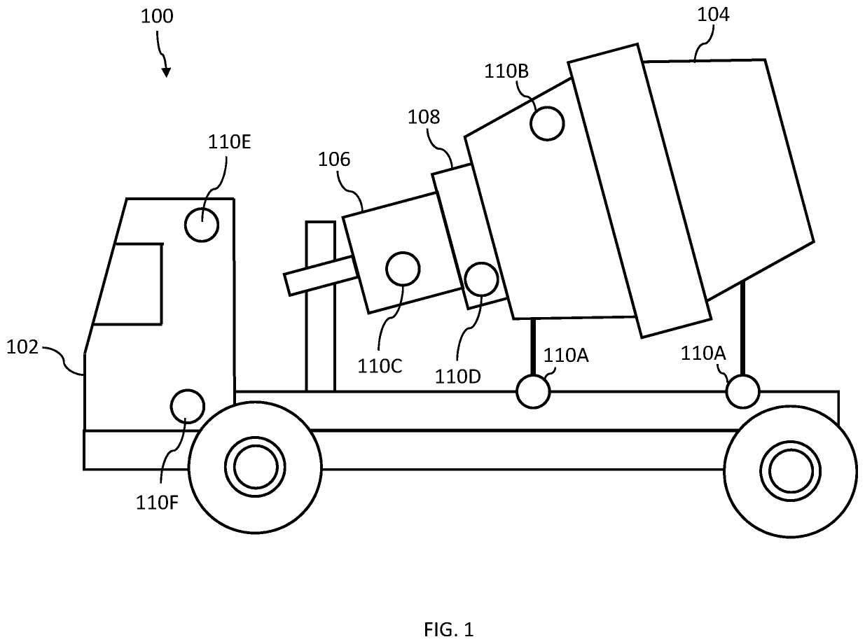

FIG. 1 shows a schematic diagram of an example concrete mixing system 100 comprising a vehicle 102 (e.g. a truck or lorry) and a concrete mixing drum 104.

The system 100 comprises a drum 104 for mixing a concrete mix (also referred to herein as a “payload”). The drum 104 is rotatable about a central axis to mix the concrete. The drum 104 may contain internal protrusions (not shown) to aid turning of the concrete mix. A drive motor 106 is coupled to drum via a gearbox 108. The drive motor 106 applies torque to the drum 104 via the gearbox 108 in order to rotate the drum 104. The drive motor 106 may be a bi-directional drive motor, i.e. capable of rotating the drum 104 both clockwise and anti-clockwise around the central axis. The drive motor 106 may be a hydraulic or electric motor.

The system 100 further comprises a plurality of sensors 110. The sensors 110 are configured to measure properties of the system 100, the vehicle 102 and/or the concrete mix in the concrete mixing drum 104. The sensors 110 may supply the sensor data to an electronic control unit (ECU), which

The plurality of sensors may comprise one or more load sensors 110A. The load sensors 110A are configured to measure the load of the concrete mixer, e.g. the mass of the drum 104 plus the mass of the concrete mix in the drum 104. In some embodiments, the one or more load sensors comprises at least two load sensors 110A: a front load sensor arranged to measure the load at the front of the drum 104 (i.e. the end closest to the drum 104 mouth); and a rear load sensor arranged to measure the load at the rear of the drum 104 (i.e. the end furthest from the drum 104 mouth). The load sensors 110A may be zeroed prior to the concrete mix being loaded to account for build-up of dried concrete in the drum

The plurality of sensors may further comprise a drum temperature sensor 110B configured to measure the temperature of the drum or the concrete in the drum directly. The temperature can be a contact temperature (either internal or external to the drum) or a non-contact temperature measurement. The temperature of the concrete mix can be an important factor in determining the slump of the concrete, since the temperature affects the evaporation rate of moisture in the concrete mix.

The plurality of sensors may further comprise one or more (e.g. a plurality) of motor state sensors 110C configured to measure the state of the motor 106 driving the drum 104, e.g. the current/voltage supplied to the motor for an electric motor, the input and output hydraulic pressures for a hydraulic motor, the motor temperature, the hydraulic fluid temperature and/or the motor rotation speed. The motor state sensors 110C may further comprise a drum speed sensor, such as an optical encoder or magnetic sensor, though this may alternatively be fitted to the drum itself, when present.

The plurality of sensors may further comprise one or more (e.g. a plurality) of gearbox state sensors 110D configured to measure the state of the drum gearbox 108, e.g. the input torque/rotation speed to the gearbox, the gearbox temperature, the gearbox fluid level, or the like. Each of the gearbox state sensors 110E may be fitted to the gearbox directly, or to some other part of the system, e.g. the motor for an input torque sensor.

The plurality of sensors may further comprise one or more location sensors 110E configured to determine the location of the vehicle 100. For example, the one or more location sensors 110E may be satellite positioning sensors, such as a GPS system.

The plurality of sensors may further comprise one or more speed sensors 110F configured to determine the speed of the vehicle 102.

The plurality of sensors may further comprise one or more of: one or more aeration sensors for measuring the aeration of the concrete mix; one or more tilt sensors configured to measure a lateral and/or longitudinal inclination of the concrete mixing drum and/or vehicle; and/or one or more accelerometers configured to measure a longitudinal and/or latitudinal acceleration of the concrete mixing drum and/or vehicle (this may alternatively be determined from real-time location data, such as GPS data). Many other examples of relevant sensors will be apparent to those skilled in the art.

The plurality of sensors may further comprise one or more vision-based sensor systems (e.g. cameras) and/or one or more LIDAR-based sensor systems. These may be used to determine additional contextual data for the journey of the concrete mixer vehicle 102. For example, an image recognition algorithm may be applied to captured images to detect, for example, traffic conditions, speed limits, lane markings, obstacles or the like.

It will be appreciated that there are multiple possible sensors or combinations of sensors that can be arranged to measure the variables required for the methods used herein. Multiple possible sensors or combinations of sensors that can be arranged to measure the variables required for the methods used herein. As an example, the input torque may be determined using a direct torque measurement via torque sensor on the drive system. Alternatively, the torque can be derived indirectly from other measurements of the motor, such as input current, input and output hydraulic pressures or the like. As another example, the drum speed may be determined from the motor speed and the gearbox ratio, or alternatively measured directly.

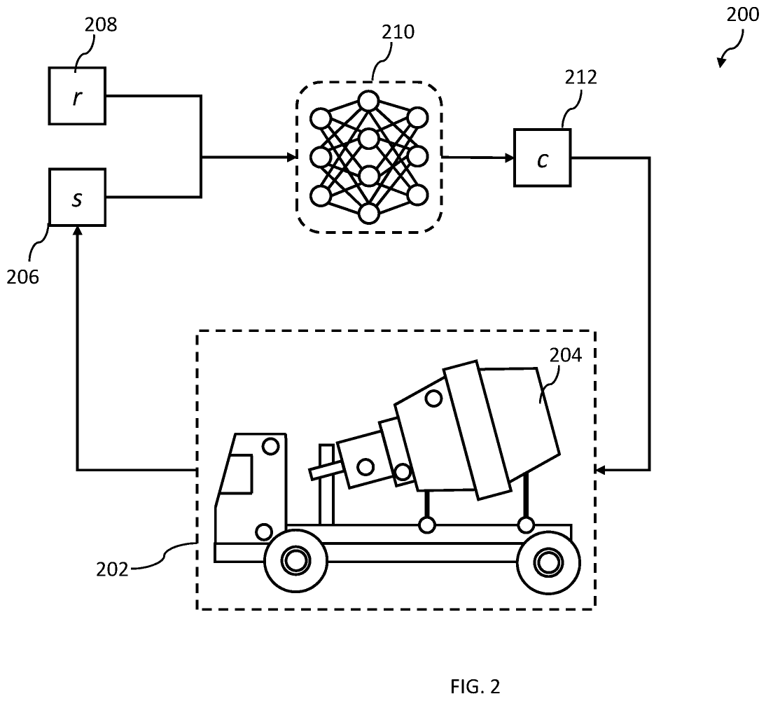

The sensors may be connected to an electronic control unit (ECU, not shown) of the concrete mixer. The ECU may use the sensor data to determine properties of the concrete drum 104, vehicle 102 and/or concrete mix, and to control these and/or other elements of the system, as described below in relation to FIGS. 2-6.

In some implementations, the vehicle 102 may operate in one of a plurality of operating modes in dependence on the sensor data collected. The operating modes may comprise two or more of: a charging mode, in which the concrete mix is being loaded into the concrete drum 104; a post-charging cycle, in which the loaded concrete mix is mixed and its initial slump value determined; a delivering mode, in which the vehicle 102 is transporting the concrete mix between the charging location and the delivery location; a pre-discharging mode, in which the slump value is checked and water may be added; a discharging mode, in which the concrete mix is discharged from the drum 104 at the delivery location; a returning mode, in which the vehicle 102 is returning from the delivery location to a further location; and/or a drum wash mode, in which the drum is being cleaned.

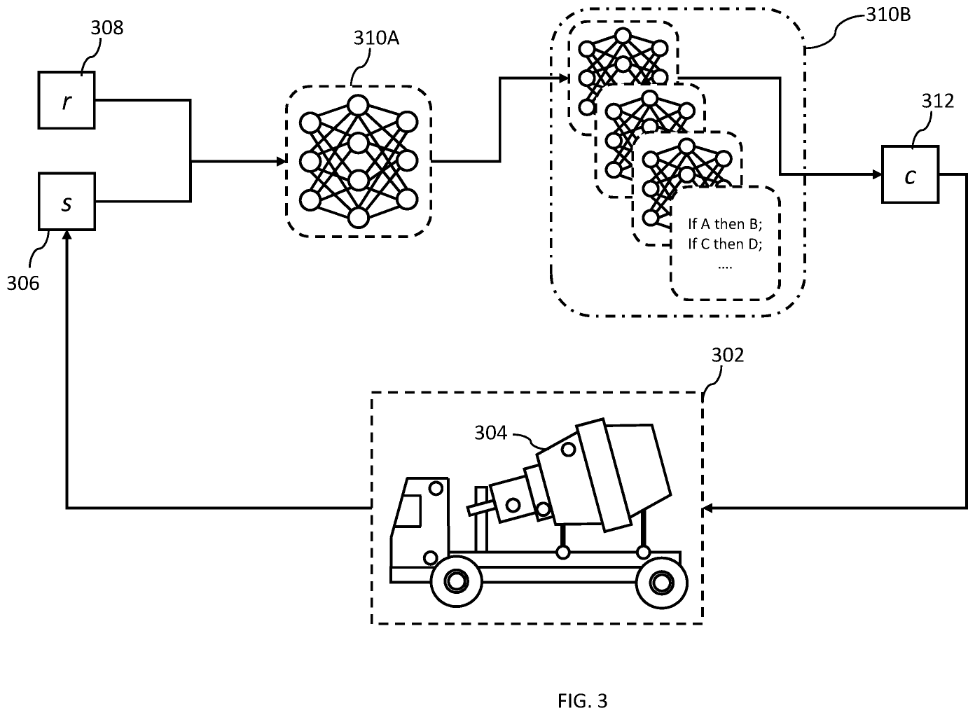

The software will detect the current mode based on inputs from the sensors. For example, one or more of the GPS location vs charging/delivery/wash-down locations, drum weight; and/or vision or LIDAR based location recognition may be used. In some implementations, the mode is detected using a gating model, for example as described in relation to FIG. 3. In some implementations, the sensor data is used to determine the mode based on one or more conditions. For example, the charging mode may be detected based on the vehicle 102 location (e.g. GPS location) corresponding to a charging location, e.g. a charging station, where the raw materials are added, mixed and hydrated, with additional additives added depending on the specific requirements. The post-charging mode may be activated based on the charging mode having ended, and the vehicle 102 being located near the charging station and moving at a speed below a threshold value. Detection of the delivery mode may be based on a payload being measured in the drum 104 and/or the vehicle having one or more scheduled delivery locations remaining. The discharging mode may be detected based on the vehicle 102 being near the discharging location, and moving at below a threshold speed. The discharging mode may be detected based on the vehicle 102 location corresponding to a delivery location and being halted. The returning mode may be detected based on the vehicle 102 having left a final scheduled delivery location and/or having a payload weight below a threshold, indicating no more concrete mix is available for delivery. The drum wash mode may be detected based on the vehicle 102 having left a final scheduled delivery location and/or being at a predefined wash-down location.

If the system cannot accurately determine the correct mode, it may suggest the correct mode, and ask user to confirm, and/or the user can also select the mode manually.

The rotation of the drum 104 may be controlled based on which mode the vehicle 102 is in.

For example, when the charging mode is automatically detected, or confirmed/selected by the operator, the system will monitor the load cells for an increase in drum weight that indicates charging has commenced. When this is detected (e.g. by an increase in drum weight above a threshold value), the mixer will begin rotating the drum 104 in the charging direction (e.g. pushing payload forwards) at the speed set by the operator as the correct charging speed. The rotation speed may, in some implementations, be manually varied during charging. This charging cycle may continue until the rate of change in the mass of the payload in the drum falls below a threshold value, e.g. dM/dt as measured by the load cells falls below a threshold value, or becomes zero. The rate of change in the payload mass may be determined using moving average to account for possible cyclical variation of as drum rotates and load cell output(s) filtered for noise reduction.

As a further example, when the post-charging mode is activated, the vehicle enters a post-charging mixing cycle in which a predefined rotation cycle (e.g. 12 rpm) is applied to ensure reliable payload mixing and minimise stratification. The post-charging mixing cycle may continue for a predetermined length of time, and/or until it is manually cancelled. At the completion of the mix cycle, a post-charging slump assessment cycle may be carried out to determine slump of the “as-charged” payload. Optionally, the assessed slump value may be confirmed by operator.

As a further example, when the delivering mode is activated, the drum 104 may be controlled based on the output of a machine-learned model, for example as described in relation to FIGS. 2-6.

As a further example, when the pre-discharge phase is entered, a pre-discharge mix cycle may be activated. Based on a determined slump value over the vehicle journey, water may be added to the concrete mix to achieve a desired slump value. The amount of water to be added may be determined automatically based on a slump model. The determined amount of water may be added automatically from a water reservoir associated with the vehicle 102. Alternatively, the value of the determined amount of water may be output to an operator, who can add the water manually.

When the discharging mode is entered, (e.g. via location and/or speed monitoring), or confirmed/selected by the operator, the system will wait for operator input to begin discharge, with option for additional signal/approval from a chute positioning indicator that confirms chute is correctly configured and positioned for discharge. When this is detected, the mixer will begin rotating in the discharging direction (pushing payload rearwards) at the speed set by the operator as the correct discharging speed. The discharge speed can also be manually altered from the predetermined setting if required. The discharging cycle may continue until either (i) a required mass of payload has been discharged, as determined by the load cells of the vehicle 102; or (ii) the operator manually ends the dis-charging mode. Note that when “barrow filling”, the discharge cycle may be repeated multiple times.

In some implementations, an optional chute wash-down may be performed after the conclusion of the discharging mode. The vehicle 102 may wait for signal from chute positioning indicator to indicate that the chute is ready for next mode.

As a further example, when a washing cycle is detected or selected by an operator, the drum may be rotated at a predefined speed for a predetermined amount of time in order to facilitate washing of the drum.

In some implementations, data collected during the use of each mode may be logged. The data may be logged in real time and save to a vehicle logger and/or cloud storage. The stored data may be used in predictive simulations of vehicle journeys, and/or as a form of quality control, e.g. in the form of a report that may be provided to a customer.

FIG. 2 shows a schematic overview of a method 200 for controlling a concrete mixing drum 204 on a concrete mixer vehicle 202. The method may be performed by one or more computing devices, such as an ECU of a concrete mixer vehicle 202.

Data representing a current state 206, s, of the concrete mixer vehicle 202 (including the state of the concrete mixing drum) is obtained. The current state 206 of the concrete mixer vehicle 202 may comprise properties/states of the vehicle 202, the mixing drum 204 and/or the concrete mix in the mixing drum 204. The current state 206 may be derived from sensor data collected by sensors coupled to the concrete mixer vehicle 202 and/or concrete mixing drum 204.

The data representing a current state 206 of the concrete mixer vehicle 202 is input into one or more machine-learned models 210, along with data representing one or more delivery requirements 208, r, for the concrete mix in the concrete mixing drum 204. The one or more machine-learned models 210 process the input data 206, 208 to generate drum rotation cycle data, c, for the concrete mixing drum 204, e.g. control commands/instructions for rotating the concrete mixing drum. This data 212 is used to control the concrete mixing drum 204, e.g. the rotation rate, tilt etc.

In this manner, the mixing drum can be controlled adaptively to meet the delivery requirements for the concrete mix, which can result in improved energy usage and safety, less spillage, and/or a reduction in the number of loads rejected as a consequence of having an incorrect slump and/or mix.

Examples of data representing the current state 206 of the vehicle may include data indicative of the current dynamical state of the concrete mixer vehicle 202. For example, the data representing the current state 206 of the vehicle may include one or more of: the a longitudinal and/or latitudinal acceleration of the concrete mixer vehicle; a longitudinal and/or latitudinal inclination of the concrete mixer vehicle; and/or a speed of the concrete mixer vehicle.

Alternatively or additionally, the data representing the current state 206 may include data indicative of the current state of the mixing drum and/or the concrete mix in the drum. For example, the data representing the current state 206 of the vehicle may include one or more of: a mass of concrete mix in the mixing drum; a concrete mixing drum power; a concrete mixing drum speed; an overturning indication; a spillage indication; and/or a chute status (e.g. from an automatic chute positioning system).

Alternatively or additionally, the data representing the current state 206 may include data indicative of the current state of the concrete mix. For example, the data representing the current state 206 of the vehicle may include one or more of: a slump of the concrete mix (for example as, as derived using the method described in co-pending GB patent application no. 2208264.8, entitled “Slump Estimation for Concrete Mixers”, the contents of which are incorporated herein by reference); a payload volume and/or mass; a payload aeration; and/or a temperature of the concrete mix or mixing drum.

Alternatively or additionally, the data representing the current state 206 may include data indicative of the current location of the vehicle. For example, the data representing the current state 206 of the vehicle may include one or more of: a vehicle location (e.g. address or longitude and latitude); an estimated remaining journey time; and/or a traffic situation.

It will be appreciated that the current state 206 may alternatively or additionally include other types of data relating to the concrete mixing vehicle.

The delivery requirements 208 may comprise a ranked/weighted set of requirements for the delivery of the concrete mix. For example, a numerical score may be associated with each of a plurality of requirements, each score indicative of the priority of that delivery requirement for the concrete mix being delivered. The set of requirements may, for example comprise two or more of: the energy usage/efficiency in delivering the concrete; safety, e.g. a safety factor; spillage, e.g. how important it is not to spill any of the concrete mix; mixing, e.g. how important it is to deliver the concrete with a target mix; and/or the slump, e.g. how important it is to deliver the concrete with a target slump. The numerical score may, for example, range for zero to a maximum value, such as ten, with a score of zero indicating that the requirement is not relevant and a maximum core indicating that the requirement is the highest priority.

The delivery requirements 208 may alternatively or additionally comprise one or more target values for properties of concrete mix. For example, a target slump value and/or a target aeration value.

The one or more machine-learned models 210 comprise one or more models that have been trained using machine-learning techniques to determine drum cycle data 212 from the current state 206 of the vehicle/mixer and the delivery requirements 208. The one or more machine-learned models 210 may be any type of machine-learned models known in the art. In general, a machine-learned model takes in input data, and processes it according to a set of learned parameter values that have been determined using a training/fitting process to generate output data.

As an example, the one or more machine-learned models 210 may comprise a neural network. A neural network is machine-learned model comprising a plurality of layers of nodes. Nodes are linked to one or more nodes in the previous layer, from which it receives inputs, and/or one or more nodes in the subsequent layer, to which it passes its activation value, by means of weighted connections. Each node calculates a respective activation value by taking a weighted sum of its inputs (were the weights are the connection weights), and applying a non-linear function (e.g. a ReLu function, tan h function, sigmoid function or the like). Each node may also be associated with a bias that is added to the weighted sum prior to applying the non-linear function. Collectively, the weights and biases (if present) form the parameters of the neural network.

The one or more machine learning models 210 may comprise one or more of: a fully connected neural network, where each node in a layer is connected to every node in the previous layer; a convolutional neural network, which applies convolutional filters to the input data; and/or a recurrent neural network, which processes input data based on an internal state that is determined based on previously input data.

Other examples of machine-learned models 210 that may be used include, but are not limited to: linear regression models; a support vector machines; and/or a random forest models.

The one or more machine-learned models have been trained using machine-learning techniques. For example, the machine-learned models may have been trained on a training dataset comprising example input current states and delivery requirements, with corresponding ground truth drum cycles (for example, derived from simulations of a mixing drum under various conditions). The example inputs are processed by the one or more models to generate candidate drum cycle data that is compared to the ground truth drum cycle data using a loss/objective function (e.g. a classification loss, an L2 loss or the like). Parameters of the one or more models (e.g. weights and biases of a neural network) are update based on the comparison, for example by applying an optimisation routine (e.g. stochastic gradient descent) to the loss/objective function.

The machine learning techniques used to train the one or more machine-learned models may alternatively comprise reinforcement learning techniques. Reinforcement learning techniques are based on an agent (i.e. a machine learning model) interacting with an environment (e.g. the concrete mixer drum) on the basis of the current state of the environment. The effect of the observation is observed, and used to generate a reward value that is used to train the agent. For example, the model being trained may receive a current state of the concrete mixer (either real or simulated) and select a drum rotation cycle to be implemented based on the current values of its parameters and these inputs. The concrete mixer (either real or simulated) is controlled based on the selected drum rotation cycle, and its state observed. Based on the observation, a reward is generated which is used to train the model. The reward may, for example, be weighted based on the delivery requirements input into the model. Examples of reinforcement learning techniques are described in “An Introduction to Deep Reinforcement Learning” (V. Francois-Lavet et al., arXiv1811.12560v2), the contents of which are incorporated herein by reference in their entirety.

Other machine learning techniques may alternatively or additionally be used.

A different set of machine-learned modes may be trained for each drum geometry, i.e. the set of models specialises in a particular type of concrete mixing drum, by training the set of models on only training data relevant to that drum type.

The drum cycle data 212 (e.g. data indicative of one or more control signals) may comprise any data that can be interpreted by the ECU to control the mixing drum. The drum cycle data 212 may, for example, comprise a target number of revolutions per unit time (e.g. revolutions per minute)/target revolution speed for the mixing drum. The drum cycle data 212 alternatively or additionally comprise a drum rotation direction (e.g. forward or backward).

For example, if the delivery requirements indicate that safety and spillage are to be prioritised, and the current state data indicates normal travelling conditions (e.g. flat road, no acceleration) then the drum cycle data 212 may indicate a continuous forward rotation at 5 rpm to avoid spillage. However, if the current state indicated a winding road (e.g. a lateral acceleration and/or a lateral angle), then the drum rotation cycle data may indicate no drum rotation, or reversing the direction of rotation.

As a further example, if the delivery requirements indicate that energy efficiency is the top priority, followed by safety and spillage, the drum cycle data may indicate that the drum will rotate at 2 rpm in forward direction to avoid spillage under normal road conditions. When lateral acceleration/angle is above threshold (indicating a winding road or sharp turns), the drum will stop (or will reverse direction if that threshold is exceeded). When a long angle/acceleration threshold is exceeded (indicating an inclined road) the drum speed may increase to 5 rpm forward to avoid spillage.

Many other examples will be familiar to the person skilled in the art.

The method may be iterated at a plurality of time steps during the delivery journey, for example every 1-5 minutes, and/or whenever a significant change in the current state of the concrete mixer vehicle is measured by the sensors.

FIG. 3 shows a schematic overview of a further method 300 for controlling a concrete mixing drum 304 on a concrete mixer vehicle 302.

The method 300 proceeds as described in relation to FIG. 2. Current state data 306 is obtained from sensor data, and input into one or more machine-learned models 310 along with one or more delivery requirements 308 for the concrete mix. The one or more machine-learned models 310 process the input data 306, 308 to generate drum rotation cycle data 312 for the concrete mixing drum 304, e.g. control commands/instructions. This data 312 is used to control the concrete mixing drum 304, e.g. the drum rotation rate/speed.

The one or more machine-learning models 310 comprises a gating model 310A configured to select a model from a set of context-specific models 310B based on the input data 306, 308. The selected model is used to generate the data indicative of one or more control commands 312 from the input data 306, 308. The gating model 310A may be a machine-learned model, or may be hand-crafted. The set of context-specific models 310B may include one or more machine-learned models, and/or one or more predefined models (i.e. models that process the input data based on predefined, untrained rules).

For example, the gating model 310A may determine a classification of the current state of the vehicle from the current state data 306 and/or the current requirements, e.g. output a distribution over a plurality of classifications, and select the most likely classification based on the distribution. A corresponding model (i.e. a model associated with that classification) is selected from the context-specific models 310B, and used to process the input data to determine the drum cycle data 312.

In such implementations, each model is specialise to generate drum rotation data for the corresponding vehicle/requirement state. Some classifications, such as when the vehicle is stationary or when a particular requirement is prioritised over all others, may correspond to straightforward drum rotation profiles that do not need the power of machine-learning. This simplifies training, since models are only required to be trained for the complex situations.

Each classification may correspond to a distinct state of the concrete mixer vehicle 302. For example, the classifications may be: a travelling/driving state; a loading state;

In some implementations, a gating model 310A is not used, and a user may manually select which model to use instead, for example by inputting or selecting a classification.

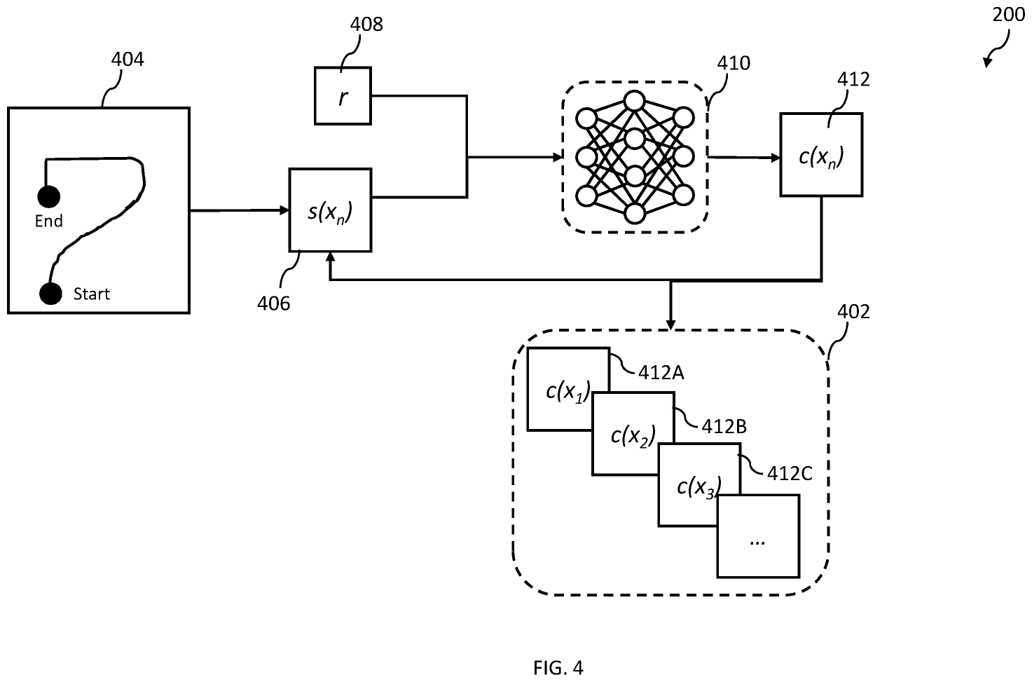

FIG. 4 shows a schematic overview of a method 400 for determining a drum rotation profile 402 for a concrete mixing drum on a concrete mixer vehicle. The drum rotation profile 402 comprises a plurality of drum rotation cycles 412A-C, each associated with a different stage of the journey route 404 of the concrete mixer.

A planned route 404 for the concrete mixer vehicle is received. Based on the route, a “current state” 406 of concrete mixer, s(xₙ), vehicle may be estimated for each stage of the route. The estimated current state 406 is input into one or more machine-learned models 410, along with one or more delivery requirements 408. The one or more machine-learned models 410 process this input to determine a drum rotation cycle 412 for that stage of the route. This is added to a set of drum rotation cycles 412A-C from previous sections of the route. The method is iterated for each section of the route 404 to generate the rotation profile.

Properties of the estimated current state 406, delivery requirements 408, machine-learned models 410 and drum rotation cycle data 412 may be the same as described in relation to FIGS. 2 and 3.

The planned route 404 comprises a start location and an end location, and a path between the two. In some implementations, the planned start of the journey may also be received, and/or a target end time.

The estimated current state 406 of the concrete mixer vehicle at each location on the route may be estimated based on properties of the roads at that location, e.g. the average speed of vehicles in that location, current traffic conditions, the inclination of the road, whether the road is straight or turning etc., Atmospheric conditions (e.g. temperature, humidity) may also be estimated based on the expected time that the concrete mixer will be at that location and a weather forecast, where the time may estimate based on the target end time and/or planned start time of the journey. In some implementations, the current state may further be based on the drum rotation cycle data from the previous section of the journey, e.g. the previous drum rotation cycle data may be used to estimate the current rate of rotation of the drum.

In some implementations, an operation mode (such as any of the operation modes described in relation to FIG. 1) may be selected for each portion of the journey based on the estimated current state 406 of the concrete mixer vehicle at that location. If the delivery mode is selected at a location, then the above described machine-learned method may be applied. For other modes, the predefined cycle for that mode will be used for that section of the journey. Modes may be enabled or disabled by a user based on user preferences or other conditions.

Based on the planned route and the determined drum rotation profile, properties of the concrete mix throughout the delivery cycle may be estimated. For example, energy, spillage, roll-over, slump and/or mix quality may be estimated through the delivery cycle.

In some implementations, an energy prediction for the delivery cycle may be predicted, predicting how much energy will be consumed on the run. In some implementations, a safety prediction may alternatively or additionally be determined, which highlights parts of the delivery route in which a user should be particularly cautious. In some implementations, a spillage prediction may alternatively or additionally be determined, which highlights parts of the delivery route where spillage is likely to occur. In some implementations, an aeration prediction may alternatively or additionally be determined, which predicts an aeration value of the concrete mix at the end of the journey based on the drum cycle for the journey. In some implementations, a slump prediction may alternatively or additionally be determined, which predicts a slump value of the concrete mix at the end of the journey based on the drum cycle for the journey.

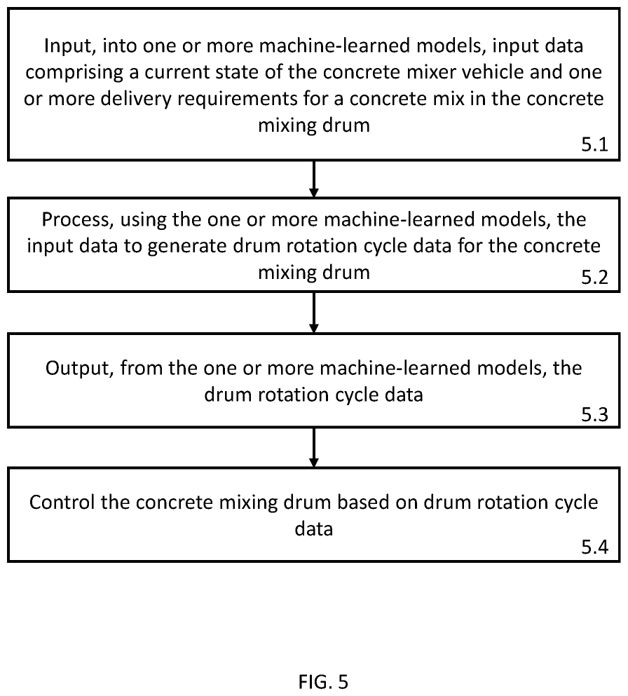

FIG. 5 shows a flow diagram of an example method for controlling a concrete mixing drum on a concrete mixer vehicle. The method may be performed by one or more computing devices, such as an ECU of a concrete mixer vehicle 202. The method may be iterated at a plurality of timesteps, for example every 1-5 minutes, e.g. every 3 minutes.

At operation 5.1, input data comprising a current state of the concrete mixer vehicle and one or more delivery requirements for a concrete mix in the concrete mixing drum is input into one or more machine learning models.

The current state of the concrete mixer vehicle may include the current state of the concrete mixing drum itself, as well as the vehicle transporting it. The current state of the concrete mixer vehicle may comprise a current vehicle state, such as one or more of: a longitudinal and/or latitudinal acceleration of the concrete mixer vehicle; a speed of the concrete mixer vehicle; a location of the concrete mixer vehicle; and/or a longitudinal and/or latitudinal inclination of the concrete mixer vehicle. The current state of the concrete mixer vehicle may comprise a current mixing drum state, such as one or more of: a drum rotation speed/rate; a concrete mixing drum power; a concrete mixing drum speed; longitudinal and/or latitudinal inclination of the concrete mixing drum; and or a concrete mixing drum temperature. The current state of the concrete mixer vehicle may comprise a current concrete mix state, such as one or more of: a current slump of the concrete mix; a current aeration state of the concrete mix; and/or a current temperature of the concrete mix. The current state of the concrete mixer vehicle may comprise a current environmental state, such as one or more of: an ambient temperature; a humidity; and/or a weather state.

The one or more delivery requirements may comprises a weighted set of predefined delivery requirements. The requirements may comprise: energy use; safety; spillage; mixing; and/or slump. The requirements may further comprise one or more target values for the concrete mix or the delivery journey, such as a target slump value of the concrete mix upon delivery, target energy usage, target delivery amount or the like.

At operation 5.2, the input data is processed by the one or more machine-learned models to generate drum rotation cycle data for the concrete mixing drum. At operation 5.3, the drum rotation cycle data is output by the one or more machine-learned models.

The one or more machine-learned models may comprise one or more of: a neural network; a recurrent neural network; a regression model; a support vector machine; and/or a random forest.

In some implementations, the one or more machine-learned models comprises a gating model and a plurality of control models. The gating model is used to select one or more control models based on the input data (i.e. the current state of the concrete mixing vehicle and/or the delivery requirements). The current state of the concrete mixer vehicle and/or the delivery requirements are processed using the gating model to determine a classification of the current state of the concrete mixer vehicle/the delivery requirements. A control model from a plurality of control models is selected based on the classification of the current state of the concrete mixer vehicle, and used to process the input data to generate the data indicative of drum rotation cycle data.

The drum rotation cycle data may define a set of instructions for rotating the concrete mixing drum. The drum rotation cycle data may comprise a target drum rotation rate/speed. The drum rotation cycle data may further comprise one or more threshold values for altering the drum rotation speed based on properties of the concrete mixing vehicle.

At operation 5.4, the concrete mixing drum is controlled based on the generated drum rotation cycle data. For example, an ECU of the concrete mixer may interpret the generated drum rotation cycle data and convert them into one or more control signals/commands for controlling elements of the concrete mixer, and transmit the control signals/commands to the relevant elements of the concrete mixer.

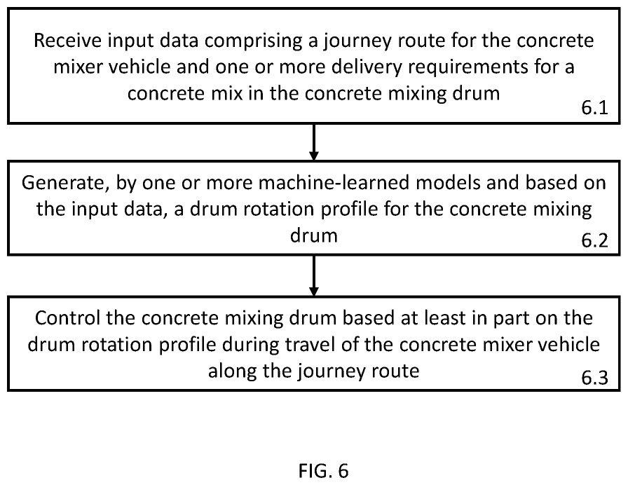

FIG. 6 shows a flow diagram of an example method for determining a drum rotation profile for a concrete mixing drum on a concrete mixer vehicle.

At operation 6.1, input data comprising a journey route for the concrete mixer vehicle and one or more delivery requirements for a concrete mix in the concrete mixing drum is received. The journey route may comprise a start location, and end location and a planned path between the two.

At operation 6.2, a drum rotation profile for the concrete mixing drum is generated by one or more machine-learned models.

Generating the drum rotation profile may comprise, for each of a plurality of locations on the planned journey route, estimating a state of the concrete mixer vehicle at a respective location on the journey route. The estimated states may be based on properties of the route at each respective location, such as the average speed, traffic conditions, road inclination etc. The estimated state may also be based on the drum rotation cycle data for the previous section/location of the journey.

Each estimated current state of the concrete mixer vehicle and the one or more delivery requirements for a concrete mix are input into the one or more machine learning models and processed to generate drum rotation cycle data for the concrete mixing drum at the respective location. The respective drum rotation cycle data for the concrete mixing drum and the respective location are added to the drum rotation profile.

At operation 6.3, the concrete mixing drum is controlled based at least in part on the drum rotation profile during travel of the concrete mixer vehicle along the journey route. For example, during the delivery journey, the ECU of the concrete mixer may monitor the location of the concrete mixing vehicle, and apply the relevant drum cycle based on the location in accordance with the drum rotation profile.

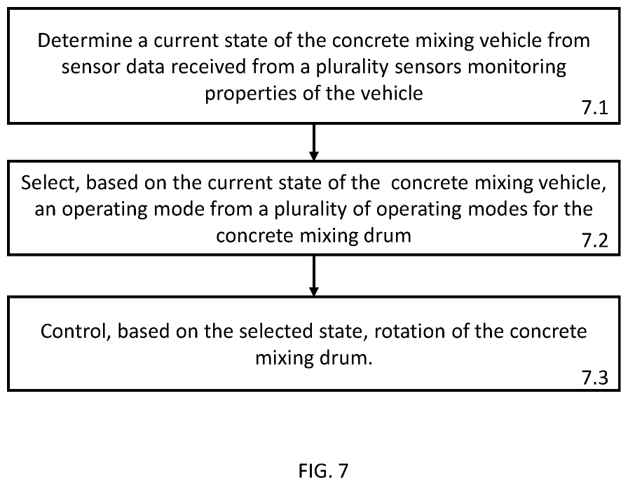

FIG. 7 shows a flow diagram of an example method for controlling a mixing drum of a concrete mixing vehicle.

At operation 7.1, a current state of the concrete mixing vehicle is determined from sensor data received from a plurality sensors monitoring properties of the vehicle. The sensor data may, for example, be any of the sensor data described in relation to FIG. 1. The current state of the vehicle may be any of the current vehicle states described in relation to FIGS. 1 or 2.

At operation 7.2, an operating mode is selected from a plurality of operating modes for the concrete mixing drum based on the current state of the concrete mixing vehicle. The plurality of operating modes may comprise any two or more of the operating modes described in relation to FIG. 1. The selection may be based on pre-defined rules, or alternatively on a trained classifier model.

For example, the plurality of operating modes may comprise a charging mode for facilitating charging (i.e. loading) of the concrete mixing drum. In this mode, the concrete mixing drum rotates in a charging direction (i.e. a direction such that the drum pushes the concrete mix forwards into the drum) at a predefined charging speed. The charging mode may be selected, for example, based on the vehicle being in a charging location, and/or a detected payload mass increasing. The charging mode may terminate automatically when the payload has stabilized, e.g. using dM/dt as measured by load cells (for example, using moving average to account for possible cyclical variation of as drum rotates and load cell output(s) filtered for noise reduction).

As a further example, the plurality of operating modes may alternatively or additionally comprise a post-charging mode for performing an initial mix of the loaded concrete mix. In this mode, the mixing drum rotates a predefined rotation rate (e.g. 12 rpm) for a predefined time (e.g. 90 seconds) to ensure reliable payload mixing (e.g. no stratification). At the completion of the mix cycle, a post-charging slump assessment may be carried out to determine slump of the “as-charged” payload. This mode may be entered automatically upon the termination of the charging mode.

As a further example, the plurality of operating modes may alternatively or additionally comprise a delivering mode. In the delivery mode, the rotation of the concrete mixing drum may be controlled using any of the methods described in relation to FIGS. 2-4.

The delivery mode may be selected based on one or more of: a payload being present in the concrete mixing drum; a post-charging cycle being completed; one or more scheduled deliveries remaining; a speed of the concrete mixing vehicle; and/or location of the concrete mixing vehicle being greater than a threshold distance from a charging station.

As a further example, the plurality of operating modes may alternatively or additionally comprise a pre-discharging mode for ensuring the concrete is properly mixed before discharge. In this mode, a slump of a concrete payload in the mixer is first determined. Based on the determined slump and a target slump value, an amount of water required to reach the target slump value is determined. The determined amount of water is added to the concrete payload. This can be done automatically or manually. The concrete drum also rotates at a predefined rate (e.g. 12 rpm) and/or for a predefined time (e.g. 90 seconds) to mix the concrete payload. The discharging mode may be selected, for example, based on the vehicle approaching a delivery location (e.g. being within a threshold distance/time of the delivery location) and/or the vehicle speed being below a threshold value.

As a further example, the plurality of operating modes may alternatively or additionally comprise a discharging mode for facilitating discharge of the concrete mix from the mixing drum. In this mode, the concrete mixing drum rotates in a discharging direction (e.g. the opposite direction to the charging direction) at a predefined charging speed to push a payload backwards in the drum. The discharging mode may be selected, for example, based on the vehicle being in a delivery location, a discharge chute location and/or a drum inclination exceeding a threshold value. The discharging mode may continue until a required amount of concrete mix has been discharged.

As a further example, the plurality of operating modes may alternatively or additionally comprise a return cycle/mode for returning the concrete mixing vehicle after a final payload delivery. In the return mode, drum rotation may be suspended. Alternatively, water may be added and a slow and/or periodic drum rotation cycle set to prevent any remaining concrete mix from setting. The return cycle may be detected based on the location of the vehicle relative to a final delivery location.

Selection of a mode may be manually overridden by a user/operator.

At operation 7.3, rotation of the concrete mixing drum is controlled based on the selected state. A rotation rate and/or rotation time for the drum may be selected based on the selected state. Water may be added to the drum based on the selected state and a target slump.

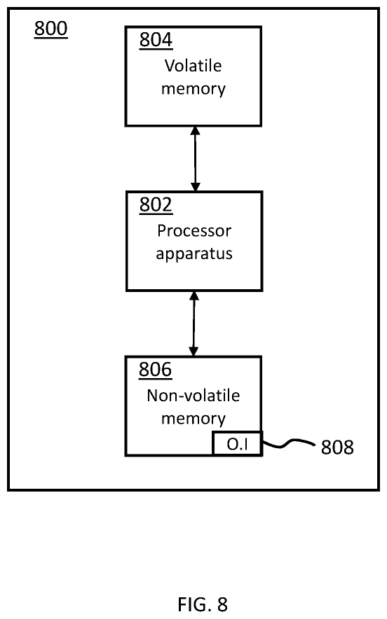

FIG. 8 shows a schematic example of a system/apparatus 800 for performing any of the methods described herein. The system/apparatus shown is an example of a computing device. The system/apparatus 800 may form at least a part of a concrete mixer, e.g. part of an ECU of a concrete mixer.

The apparatus (or system) 800 comprises one or more processors 802. The one or more processors control operation of other components of the system/apparatus 800. The one or more processors 802 may, for example, comprise a general-purpose processor. The one or more processors 802 may be a single core device or a multiple core device. The one or more processors 802 may comprise a Central Processing Unit (CPU) or a graphical processing unit (GPU). Alternatively, the one or more processors 802 may comprise specialised processing hardware, for instance a RISC processor or programmable hardware with embedded firmware. Multiple processors may be included.

The system/apparatus comprises a working or volatile memory 804. The one or more processors may access the volatile memory 804 in order to process data and may control the storage of data in memory. The volatile memory 804 may comprise RAM of any type, for example, Static RAM (SRAM) or Dynamic RAM (DRAM), or it may comprise Flash memory, such as an SD-Card.

The system/apparatus comprises a non-volatile memory 806. The non-volatile memory 806 stores a set of operation instructions 808 for controlling the operation of the processors 802 in the form of computer readable instructions. The non-volatile memory 806 may be a memory of any kind such as a Read Only Memory (ROM), a Flash memory or a magnetic drive memory.

The one or more processors 802 are configured to execute operating instructions 808 to cause the system/apparatus to perform any of the methods described herein. The operating instructions 808 may comprise code (i.e. drivers) relating to the hardware components of the system/apparatus 800, as well as code relating to the basic operation of the system/apparatus 800. Generally speaking, the one or more processors 802 execute one or more instructions of the operating instructions 808, which are stored permanently or semi-permanently in the non-volatile memory 806, using the volatile memory 804 to store temporarily data generated during execution of said operating instructions 808.

Any mentioned apparatus and/or other features of particular mentioned apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description, it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures.

1. A method for controlling a concrete mixing drum on a concrete mixer vehicle, the method comprising, for each of a plurality of time-steps:
inputting, into one or more machine-learned models, input data comprising a current state of the concrete mixer vehicle and one or more delivery requirements for a concrete mix in the concrete mixing drum;
processing, using the one or more machine-learned models, the input data to generate a drum rotation cycle data for the concrete mixing drum;
outputting, from the one or more machine-learned models, the drum rotation cycle data; and
controlling the concrete mixing drum based on the generated drum rotation cycle data.

2. The method of claim 1, wherein the current state of the concrete mixer vehicle is at least in part derived from sensor data collected from sensors coupled to the concrete mixer drum.

3. The method of claim 1 or 2, wherein the current state of the concrete mixer vehicle comprises one or more of: a longitudinal and/or latitudinal acceleration of the concrete mixer vehicle; a longitudinal and/or latitudinal inclination of the concrete mixer vehicle; a speed of the concrete mixer vehicle; a remaining journey time of the concrete mixer vehicle; a current slump of the concrete mix in the concrete mixing drum; a current location of the concrete mixer vehicle; a concrete mixing drum power; a concrete mixing drum speed; and or a temperature.

4. The method of any preceding claim, wherein the one or more delivery requirements comprise a plurality of scores, each corresponding to weighting of a predefined requirement associated with delivery of the concrete mix in the concrete mixing drum.

5. The method of claim 4, wherein the predefined requirements comprise one or more of: energy use; safety; spillage; mixing; and/or slump.

6. The method of any preceding claim, wherein the delivery requirements comprise a target slump value of the concrete mix upon delivery.

7. The method of any preceding claim, wherein processing the input data to generate the rotation cycle data for the concrete mixing drum comprises:
processing the current state of the concrete mixer vehicle using a gating model to determine a classification of the current state of the concrete mixer vehicle;
selecting a control model from a plurality of control models based on the classification of the current state of the concrete mixer vehicle; and
processing, using the selected control model, the input data to generate the drum rotation cycle data,
wherein the gating model and/or plurality of control models comprises the one or more machine-learned models.

8. The method of any preceding claim, wherein the one or more machine-learned models comprises: a neural network; a recurrent neural network; a reinforcement learning model; a regression model; a support vector machine; and/or a random forest.

9. A method for determining a drum rotation profile for a concrete mixing drum on a concrete mixer vehicle, the method comprising:
receiving input data comprising a journey route for the concrete mixer vehicle and one or more delivery requirements for a concrete mix in the concrete mixing drum;
generating, by one or more machine-learned models and based on the input data, a drum rotation profile for the concrete mixing drum, the drum rotation profile comprising a set of control commands for controlling the concrete mixing drum, the control commands each associated with respective part of the journey route; and
controlling the concrete mixing drum based at least in part on the drum rotation profile during travel of the concrete mixer vehicle along the journey route.

10. The method of claim 9, generating the drum rotation profile for the concrete mixing drum comprises, for each of a plurality of locations on the journey route:
estimating a state of the concrete mixer vehicle at a respective location on the journey route;
inputting, into the one or more machine-learned models, data comprising the estimated current state of the concrete mixer vehicle and the one or more delivery requirements for a concrete mix;
processing, using the one or more machine-learned models, the data to generate respective drum rotation cycle data for the concrete mixing drum at the respective location; and
adding the respective drum rotation cycle data for the concrete mixing drum and the respective location to the drum rotation profile.

11. The method of claim 10, wherein the estimated state of the concrete mixer vehicle at a respective location on the journey route comprises one or more of: a longitudinal and/or latitudinal acceleration of the concrete mixer vehicle; a longitudinal and/or latitudinal inclination of the concrete mixer vehicle; a speed of the concrete mixer vehicle; a remaining journey time of the concrete mixer vehicle; a current slump of the concrete mix in the concrete mixing drum; a current location of the concrete mixer vehicle; a concrete mixing drum power; a concrete mixing drum speed; and or a temperature.

12. The method of any of claims 9 to 11, wherein the one or more delivery requirements comprise a plurality of scores, each corresponding to weighting of a predefined factor associated with delivery of the concrete mix in the concrete mixing drum.

13. The method of any of claims 9 to 12, wherein the method further comprises:
determining, based on the drum rotation profile for the concrete mixing drum, one or more delivery properties of the journey route; and
outputting the one or more delivery properties of the journey route,
wherein the one or more properties comprise one or more of: an energy prediction for the journey; a safety prediction for the journey; a spillage prediction for the journey; a mixing prediction for the journey; and/or a slump prediction for the journey.

14. A computer implemented method for controlling a mixing drum of a concrete mixing vehicle, the method comprising:
determining a current state of the concrete mixing vehicle from sensor data received from a plurality sensors monitoring properties of the vehicle;
selecting, based on the current state of the concrete mixing vehicle, an operating mode from a plurality of operating modes for the concrete mixing drum; and
controlling, based on the selected state, rotation of the concrete mixing drum.

15. The method of claim 14, wherein the plurality of operating modes comprises a delivering mode in which the rotation of the concrete mixing drum is controlled using the method of any of claims 1 to 8, and wherein the delivery mode is selected based on one or more of: a payload being present in the concrete mixing drum; a post-charging cycle being completed; one or more scheduled deliveries remaining; a speed of the concrete mixing vehicle; and/or location of the concrete mixing vehicle.

16. The method of any of claim 14 or 15, wherein the plurality of operating modes comprises a charging mode in which the concrete mixing drum rotates in a charging direction at a predefined charging speed to push a payload forwards in the drum.

17. The method of any of claims 14 to 16, wherein the plurality of operating modes comprises a discharging mode in which the concrete mixing drum rotates in a discharging direction at a predefined charging speed to push a payload backwards in the drum.

18. The method of any of claims 14 to 16, wherein the plurality of operating modes comprises a pre-discharging mode, in which:
a slump of a concrete payload in the mixer is determined;
an amount of water required to reach a target slump value is determined based on the determined slump of the concrete payload and a target slump value;
the determined amount of water is added to the concrete payload; and
the concrete drum rotates at a predefined rate to mix the concrete payload.

19. A computer program product comprising computer readable instructions that, when executed by a computing system, cause the system to perform the method of any preceding claim.

20. A concrete mixer vehicle comprising:
a concrete mixing drum;
control apparatus configured to cause the concrete mixer vehicle to perform the method of any of claims 1 to 18.
